(19) United States
(12) Patent Application Publication
(10) Pub. No.: US 2024/0231326 A1
(43) Pub. Date: Jul. 11, 2024

(54) SURFACE MARKING ROBOTS AND FLOOR PLANS

(71) Applicant: Hewlett-Packard Development Company, L.P., Spring, TX (US)

(72) Inventors: Lluis ABELLO ROSELLO, Sant Cugat del Valles (ES); Ramon VIEDMA PONCE, Sant Cugat del Valles (ES); Marina RAMON BORRAS, Sant Cugat del Valles (ES)

(73) Assignee: Hewlett-Packard Development Company, L.P., Spring, TX (US)

(21) Appl. No.: 18/573,905

(22) PCT Filed: Jun. 23, 2021
(86) PCT No.: PCT/US2021/038686

§ 371 Date: Dec. 22, 2023

(51) Int. Cl. G05B 19/4155; B41M 5/00; E04G 21/18; G05D 1/246; G05D 105/00; G05D 107/90

(52) U.S. Cl. CPC G05B 19/4155; B41M 5/0041; E04G 21/18; G05D 1/2465; G05B 2219/45134; G05D 2105/17; G05D 2107/90

(57) ABSTRACT

In an example, a method of operating a surface marking robot comprises receiving a first digital representation of a floor plan comprising a plurality of floor plan features, and identifying a specific floor plan feature corresponding to a specific printing resources consumption. In response to identifying the specific floor plan feature, the method comprises modifying the first digital representation to produce a second digital representation in which the specific floor plan feature is replaced by an alternative floor plan feature corresponding to an alternative printing resources consumption which is reduced compared to the specific printing resources consumption.

### BACKGROUND

Surface marking robots may be used to draw or print lines on a surface by depositing printing material while moving.

### BRIEF DESCRIPTION OF THE DRAWINGS

Non-limiting examples will now be described with reference to the accompanying drawings, in which:

FIG. 1 shows a schematic flow chart of an example method.

FIG. 2 shows a schematic flow chart of another example method.

FIG. 3 shows a schematic flow chart of yet another example method.

FIG. 4 shows a schematic flow chart of a further example method.

FIG. 5 shows a schematic representation of an example surface marking robot.

FIG. 6 shows another schematic representation of an example surface marking robot.

FIG. 7 shows a schematic representation of an example machine readable medium.

### DETAILED DESCRIPTION

Surface marking robots may be, for example, autonomous vehicles which may be used for printing images such as lines on surfaces for applications such as construction and street marking. Such applications can in some examples involve printing images on surfaces which may extend tenth of square meters or more. Due to the extent of the surface types involved, printing resources such as printing time, amount of printing material used, or surface marking robot energy should be used appropriately. Introducing capabilities to manage printing resources forms the foundation of the present disclosure, resource management being for example introduced by modifying a digital representation of a floor plan in order to reduce a consumption of at least some of the printing resources.

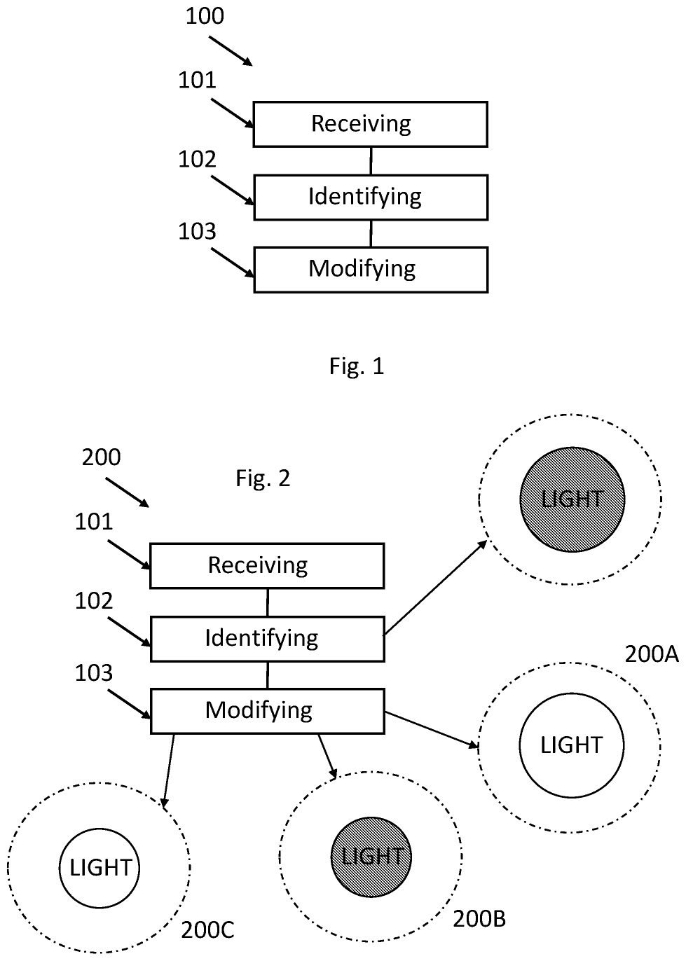

FIG. 1 illustrates an example method 100 of operating a surface marking robot. A surface marking robot should be understood as a self-propelled apparatus to apply a printing material on a surface. In some examples, the surface marking robot comprises a motor, for example an electric motor, and a source of energy such as a battery. The surface marking robot may be propelled by friction, for example by a movement of wheels on the surface, or may be air-lifted. The surface may be a flat surface or a three dimensional surface. The surface may for example be a concrete, a wooden or a composite material surface. The surface may be smooth or may be rough. The surface may comprise holes or obstacles. In some examples, the surface marking robot is operated by a computer system comprising a processor and a memory.

As illustrated in block 101, example method 100 comprises receiving a first digital representation of a floor plan, the first digital representation comprising a plurality of floor plan features. In some examples, the receiving takes place at a network or communication module of a computer system operating the surface marking robot. A digital representation of a floor plan should be understood as a digital data file comprising digital data associated to a floor plan. The digital representation may be in a form of higher level information, or in the form of lower level information. Higher level information should be understood by information more susceptible to be understood by a human, for example comprising objects. Lower level information should be understood by information more susceptible to be handled for example by firing electronics of nozzles of a printhead. The digital representation may correspond to a specific stage of a printing pipeline. A printing pipeline may for example start with an input file, or raw input file, i.e. a digital representation of a drawing provided by a user, for example in a DXF (Drawing Exchange Format), DWG (DraWinG) or BIM (Building Information Management) format. The input file may, in the printing pipeline, be processed to be parsed in layers, for example for checking that relevant printing information is contained in the file. The raw input file, or the input file parsed by layers, may be processed to detect obstacles such as walls, columns, staircases or staircase holes which would be tangible and present on the surface to be marked and may impact a trajectory or path to be followed by the robot. The raw input file, layer parsed file or file analyzed for obstacles may be processed to sort and group clusters of graphical representations such as lines or text for example, whereby such clusters may comprise graphical representations to be printed together in a same pass or swath of the surface marking robot, such same pass or swath being in some examples uninterrupted and/or following a same straight line. The raw input file, layer parsed file, file analyzed for obstacles, or sorted and grouped file may be processed for path planning, for example in order to sort an order in which graphical representation elements such as floor plan features may be printed, while avoiding obstacles and reducing a printing time. The raw input file, layer parsed file, file analyzed for obstacles, sorted and grouped file or file processed for path planning may be processed for printing, for example to be processed by a state machine of a controller of a print apparatus of the surface marking robot. The digital representation of a floor plan may correspond to any of such example files as well as other example files which may be used in a printing pipeline. In some examples, the first digital representation is a sorted and grouped file. A floor plan should be understood as a two dimensional or three dimensional representation of a structure such as, for example, a building, such representation comprising for example different rooms, spaces or other physical features of such building. In some examples, the floor plan is at a one to one scale. In some examples, the floor plan comprises floor plan features, floor plan features corresponding to objects or characteristics included in the floor plan such as walls, windows, doors, staircases, elevator cases, sinks, types of finish, construction methods, materials, symbols for electrical, gas, or water supply features, etc.

As illustrated in block 102, example method 100 comprises identifying a specific floor plan feature of the plurality of floor plan features, the specific floor plan feature corresponding to a specific printing resources consumption. The identification may take place at a feature identification module of a computer system operating the surface marking robot. Such feature identification module may be integrated in the robot or may be provided as a module remote from the robot. The specific floor plan feature may for example be one of a wall, window, door, staircase, elevator case, sink, type of finish, material, construction method, or symbol for electrical, gas, or water supply feature. The specific floor plan feature corresponds to, or is associated to, a specific printing resources consumption. The specific printing resource consumption may be of different resource types, for example be one of a printing time, for example in seconds or minutes, for printing the specific floor plan feature, a printing material amount, for example in grams or milliliters, for printing the specific floor plan feature, or a surface marking robot energy, for example in Joules, to be consumed for printing the specific floor plan feature. In some examples, such specific printing resource consumption may refer to more than one printing resource consumption type, whereby such specific printing resource consumption may be submitted to different weights and/or to a hierarchy in composing a specific resource consumption of the specific floor plan feature taking such resources of different types into account. In some examples, printing time is assigned a higher weight, or a higher hierarchical consumption level than printing material amount. In some examples, a specific printing resource consumption weight or hierarchy may be modified over time, for example to take into account that a surface marking robot has energy reserves below a predetermined threshold, thereby raising weight or hierarchical level of energy consumption to, for example, avoid depleting a battery of the surface marking robot. In other examples where spare energy may be available, printing time may be assigned a higher weight or hierarchical level in composing a specific resource consumption of the specific floor plan feature when compared to, for example energy consumption.

As illustrated in block 103, example method 100 comprises, in response to identifying the specific floor plan feature, modifying the first digital representation to produce a second digital representation, whereby the specific floor plan feature is replaced in the second digital representation by an alternative floor plan feature, the alternative floor plan feature corresponding to an alternative printing resources consumption, whereby the alternative printing resources consumption is reduced compared to the specific printing resources consumption. In some examples, the reduction of resources consumption represents more than 10%, more than 20%, more than 30%, more than 40% or more than 50% of the specific printing resources consumption.

As illustrated in example method 200, comprising blocks 101-103 as described in the context of method 100, the reduced printing resources consumption may be a reduced printing material, for illustration purposes, in this specific example, the specific floor plan feature is a lighting point. In such an example, the specific floor plan feature may comprise both an outline and a filled area within the outline, while the alternative floor plan feature 200A may comprise the outline without the filled area, thereby reducing printing material amount consumption. In such an example, surface marking robot energy is also a reduced printing resource. In another example, not illustrated here, the specific floor plan feature may be a plug. Another possible alternative floor plan feature 200B permits reducing printing resources consumption by reducing a diameter of the specific floor plan feature. Another possible alternative floor plan feature 200C permits reducing printing resources consumption by both reducing a diameter of the specific floor plan feature and removing a filled area.

As illustrated in example method 300, comprising blocks 101-103 as described in the context of method 100, the reduced printing resources consumption may be a reduced printing time, the specific floor plan feature being in this example a wall. In such an example, the specific floor plan feature may comprise the outline of the wall comprising two parallel lines separated by a distance representing the wall thickness, while the alternative floor plan feature comprises a single line and an indication as to the wall thickness permitting printing of the alternative floor plan feature in less time, using less printing material, and/or using less surface marking robot energy compared to the printing of the specific floor plan feature. In such an example, surface marking robot energy is also a reduced printing resource. In other examples, not illustrated here, the specific floor plan feature may be a window or a door. In the illustrated example, the specific floor plan feature comprises two parallel lines separated by X cm, and several possible alternative floor plan features are illustrated as follows. Alternative floor plan feature 300A comprises a single line and arrows illustrating the wall thickness, the arrows having a length of X. Alternative floor plan feature 300B comprises a single line and arrows illustrating the wall thickness, the arrows having a length of less than X, the alternative floor plan feature further comprising text indicating the wall thickness. In both examples 300A and 300B, the single line corresponds to one of both lines forming the specific floor plan feature, the arrow or arrows indicating the direction in which the location of the other one of both lines forming the specific floor plan feature is located. In another alternative floor plan possibility illustrated as 300C, the single line of the alternative floor plan feature corresponds to a middle line between both lines forming the specific floor plan features, as well as arrows indicating the wall thickness in this case on both sides of the single line. In another alternative floor plan possibility illustrated as 300D, the single line is combined with one or more T shapes illustrating the wall thickness. In other examples, not illustrated here, the specific floor plan feature may be a window or a door. In further examples, the specific floor plan features comprises a combination of sub features selected from one or more walls, one or more windows, one or more lighting points, and/or one of more power plugs. Symbols other than arrows, T shapes or text maybe considered in alternative floor plan features to convey information equivalent to the information conveyed by the specific floor plan feature, permitting reducing printing resources consumption of one or more types.

Example method 400, which comprises blocks 101-103 already described in the context of any of methods 100, 200 or 300, further comprises block 404 of applying printing material onto a floor using the surface marking robot and based on the second digital representation. This permits effectively realizing the printing resources reduction while obtaining the desired floor marking.

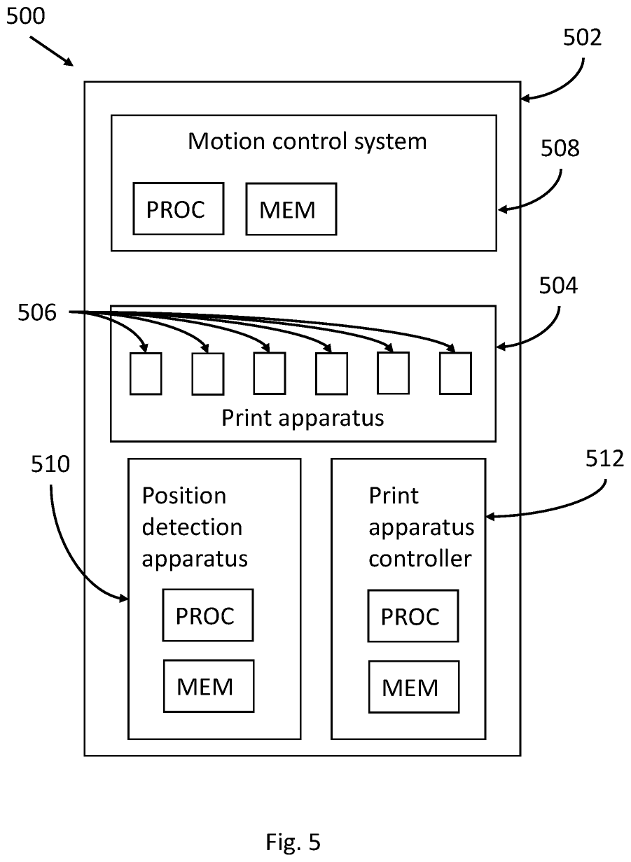

FIG. 5 shows a surface marking robot 500 comprising a body 502 and a print apparatus 504 comprising a plurality of print nozzles 506 mounted on the body 502. The robot 500 also includes a motion control system 508, to cause the robot 500 to travel along the surface with an intended path. For example, the motion control system 508 may comprise a plurality of wheels connected with a motor, or any suitable propulsion system. In some examples, the motion control system 508 may also comprise a processor to receive and execute instructions defining an intended path or trajectory for the robot 500 to follow. In some examples the motion control system 508 may comprise a machine readable medium or memory having stored instructions defining a predefined intended path for the robot 500 to follow. In other examples the motion control system 508 may define an intended path for the robot 500. In some examples, the motion control system 508 may comprise control circuitry to control wheels, a motor or other propulsion apparatus mounted on the body 502 of the robot 500 to control a direction (and in some examples, speed) of the robot 500. In some examples, the motion control system may be a microcontroller following a trajectory servo in communication with a propulsion system comprising motor driver electronics to supply force to a set of wheels.

The robot 500 also includes a position detection apparatus 510 for detecting a position of the robot 500. The position detection apparatus 510 may for example, comprise a sensor, or, in some examples, a plurality of sensors. The sensor(s) may be any kind of suitable position sensor such as rotary encoders located on wheels of the robot, a camera located on the body of the robot, a Light Detection and Ranging (LIDAR) system, an inertial mechanical unit to sense accelerations and direction of the robot, a combination including at least some of the previously-mentioned position sensors or any other suitable kind of position sensor. In some examples, information from the sensor(s) may be compared with a servo path to detect deviations. For example, accelerations in an axis other than that defined by the servo path can indicate that the robot is not following the defined servo path. In some examples a determination that rotary encoders on the robot's wheels are not increasing steadily can provide an indication that the robot has deviated from the defined path. The position detection apparatus 510 may comprise processing circuitry to determine whether a determined position matches an intended path of the robot 500, which may be held by the motion control apparatus 508. In some examples, the robot's position may be monitored by a sensor, for example a camera, located externally to the robot and the position detection apparatus may comprise a processor to receive position information for the robot. In some examples, the position detection apparatus 510 and/or the motion control apparatus 508 may determine a magnitude and direction of the difference between the robot's current position and its intended path and may correct the path of the robot accordingly. In some examples, a computer system operating the robot may be external to the robot, the computer system comprising in some examples a sensor such as a camera of the position detection apparatus, such computer system external to the robot operating as an external robotic station. In some examples, the position detection apparatus may comprise a total station theodolite (TST) located on the robot.

In use of the robot 500, the print apparatus 504 deposits printing material onto the surface, for example from a nozzle of the plurality of nozzles 506, for example to form a line, as the robot 500 follows an intended path. In some examples, upon detection by the position detection apparatus that the position of the robot 500 has deviated from the intended path, the motion control system 508 can in some examples perform a correction to a direction of travel of the robot 500 such that the robot 500 returns to the intended path.

The robot 500 also includes a controller 512 of the print apparatus. In some examples, the controller 512 comprises a processor. In some examples, the processor of the controller 512 is used as a single processor of the surface marking robot, being a processor for the motion control system and for the position detection apparatus also. In some examples, more than one processors are used in the surface marking robot. In the example illustrated in FIG. 5, each of the motion control system, position detection apparatus and print apparatus controller have their own processor, and an own memory or non-transitory machine-readable storage medium.

Upon reception, by the controller 512 of the print apparatus, of a first digital representation of a floor plan, for example as illustrated in any of the examples methods hereby described, the controller is to identify a specific floor plan feature of the first digital representation corresponding to a specific printing resources consumption.

As illustrated for example in any of the methods hereby described, the controller of the print apparatus is to replace the specific floor plan feature by an alternative floor plan feature, the alternative floor plan feature corresponding to an alternative printing resources consumption, whereby the alternative printing resources consumption is reduced compared to the specific printing resources consumption.

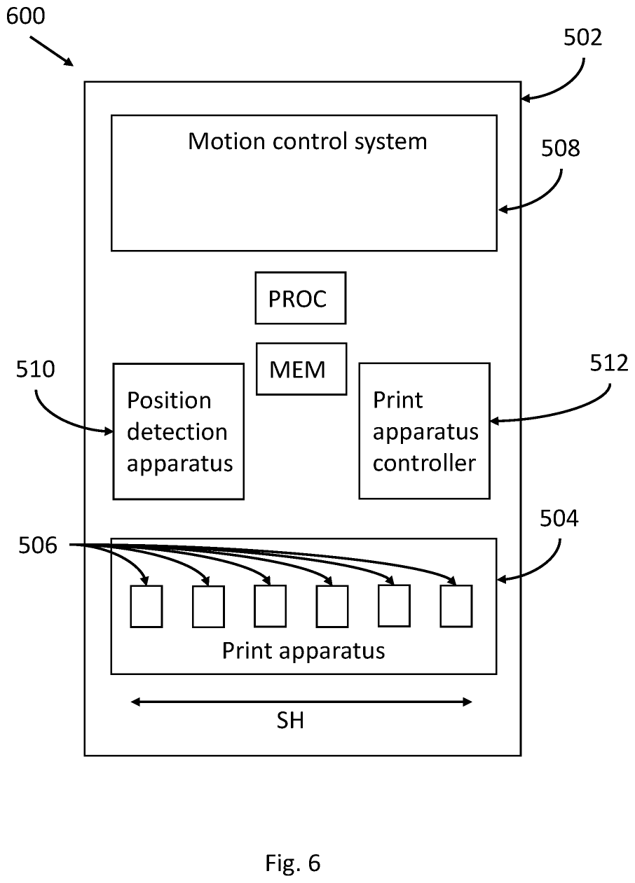

FIG. 6 illustrates another example surface marking robot 600 comprising components 502-512 as described in the context of example surface marking robot 500. In this example illustrated in FIG. 6, the motion control system, position detection apparatus and print apparatus controller share a single processor, and a single memory or non-transitory machine-readable storage medium. In this example, the plurality of print nozzles define a swath height SH. A swath height should be understood as a maximum width along which the surface marking robot may mark a floor or surface as it moves along its path. In some examples, the swath height may correspond to a distance separating nozzles along a direction substantially perpendicular to a direction of movement of the surface marking robot, in some examples the maximum distance separating nozzles along a direction substantially perpendicular to a direction of movement of the surface marking robot. In some examples, the specific floor plan feature has a width exceeding a printhead swath height, wherein the alternative floor plan feature has a width of less than or equal to the printhead swath height, and whereby the specific printing resources consumption and the alternative printing resources consumption each correspond to a printing time.

In some examples, the swath height SH is smaller than a diameter, outline or envelope of the specific floor plan feature as illustrated for example in FIG. 2, the specific floor plan feature has a width (in this case, the diameter of the “LIGHT” circle) exceeding a printhead swath height, wherein the alternative floor plan feature has a width of less than or equal to the printhead swath height as illustrated in the cases 200B or 200C.

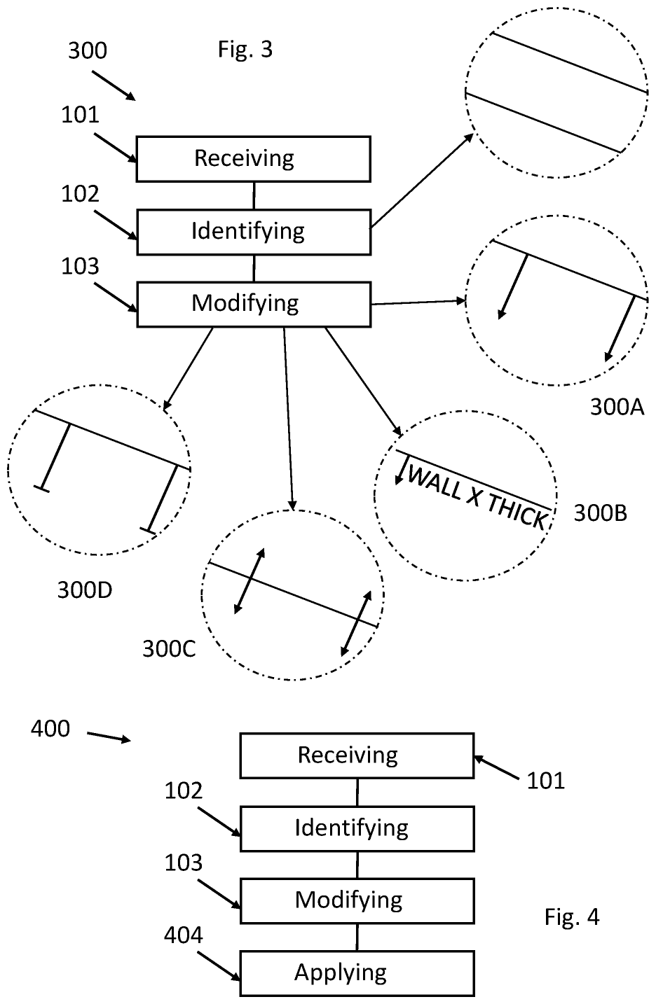

In some examples, the swath height SH is smaller than a distance separating two parallel lines representing a wall, door or window such as distance X separating the two parallel lines of the specific floor plan feature of FIG. 3, the specific floor plan feature having a width (in this case, X) exceeding a printhead swath height, wherein the alternative floor plan feature has a width of less than or equal to the printhead swath height as illustrated in case 300B.

In some examples, in particular when the alternative floor plan feature has a width of less than or equal to the printhead swath height and when the specific floor plan feature had a width exceeding a printhead swath height, the alternative floor plan feature may be printed in a single swath instead of more than a single swath. As illustrated in FIG. 3, in some cases the printing of the specific floor plan feature may correspond to two different swath, being one swath per line, whereas the printing of the alternative floor plan feature 300B may be obtained in a single swath, thereby potentially permitting printing the alternative floor plan feature in about 50% of the time to print the specific, unmodified, floor plan feature. In some examples, such time saving may be applied to relatively elongated features such as a wall, elongated features having for example a length exceeding 10 times their width according to this disclosure, whereby printing such features would take place by the surface marking robot following a path along the length of the feature while applying the printing material as described for example in block 404 of FIG. 4.

In some examples, the nozzles 506 are fixed relative to the body 502, e.g. the nozzles are mounted on the body 502 rather than being mounted on a moveable print carriage. Mounting the nozzles 506 in a fixed arrangement relative to the body 502 provides a more robust arrangement than mounting on a moveable printer carriage, which improves ease of maintenance for the robot 500.

In some examples, the nozzles 506 are arranged in a row, perpendicular to a direction of travel of the robot 500. This arrangement enables obtaining a relatively large swath height.

In some examples, the nozzles 506 are spaced from each other by a distance of between 5 and 20 mm. This arrangement enables obtaining a relatively large swath height. In some examples, 32 nozzles are used, the nozzles being separated by a distance of 1.8 mm. In some example, a higher number of nozzles are provided, for example in order to improve a printing resolution. In some examples, more than 1000 nozzles are used, such nozzles being placed in an array configuration and being separated by distances permitting obtaining a resolution of 1200 dots per inch (dpi) or about 47 dots per mm.

In some examples, the plurality of nozzles 506 comprises between 5 and 20 nozzles.

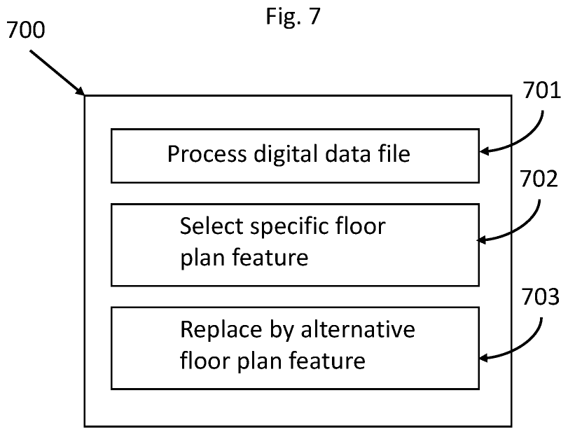

FIG. 7 shows a schematic representation of an example tangible machine readable medium 700. Such medium 700 may for example correspond to the block “MEM” of FIG. 6, or to the block “MEM” of the print apparatus controller 512 of FIG. 5. In other examples, medium 700 may be remote from and external to the surface marking robot and be in communication with the robot using a wireless communication system or module such as Wi-Fi, Bluetooth, or any suitable communication system or module.

Medium 700 is encoded with instructions executable by a processor of a controller of a print apparatus of a surface marking robot and comprises instructions 701 to process a digital data file corresponding to a floor plan, the first digital data file comprising a plurality of floor plan features. The processing can for example comprise to identify a plurality of floor plan features, or a specific floor plan feature. The processing may function in different manners, for example in function of a format of the digital data file. In some examples, the digital data file comprises objects, each object comprising characteristics, such characteristics facilitating the processing, such characteristics comprising for example a shape characteristic (line or circle, for example), a dimension characteristic (width, length or surface area for example) or a function characteristic (wall or door for example). In other examples, the digital data file may comprise a bit map, the processing involving detecting shapes such as lines or circles in the bit map. The processing may involve classifying features for example in function of their shape (for example length or width) or area fill (for example quantity of filled area compared to outlines). In some examples, the plurality of floor plan features are classified according to floor plan feature classes, such classes permitting for example to identify a function of the floor plan feature concerned. In some example, such classes are provided in the digital data file provided as an input file, for example in the case of processing a BIM input file as digital data file. In some examples, the floor plan feature classes comprise a wall class, the specific floor plan feature pertaining to the wall class, the specific floor plan feature comprising hosted wall elements, the specific floor plan feature comprising information related to the hosted wall elements, and information such as the wall thickness information, thereby facilitating, for example, comparing such thickness to a swath height as discussed in the context of FIG. 6. Example hosted wall elements may be windows, doors, lighting points, radiators, apertures or plugs. In some examples, the digital data file is a specific layer of a three dimensional representation of the floor plan, such digital data file being extracted from another data file corresponding to the three dimensional representation of the floor plan.

In some examples, the instructions 701 to process comprise to detect, in the digital data file, two parallel lines offset by a distance below a first predetermined threshold, the two parallel lines having a length above a second predetermined threshold, the two parallel lines corresponding to the selected specific floor plan feature, which is likely to be a wall feature. This permits detecting a feature which may, in some examples, get replaced by an alternative floor plan feature comprising a single line and a wall thickness indication as illustrated for example in FIG. 3. In some examples, the first threshold corresponds to a swath height of the surface marking robot. In some examples, the second threshold has a value of more than 5 times the first threshold, of more than 10 times the first threshold, or of more than 20 times the first threshold.

Medium 700 comprises instructions 702 to select a specific floor plan feature of the plurality of floor plan features. In some examples, the selection may be in function of characteristics of the floor plan features. In some examples, the selection may take into account a classification resulting from the processing 701 or directly provided by the digital data file. In some examples, the specific floor plan feature is elongated. In some examples, the specific floor plan feature is a wall, or is classified as a wall. In some examples, the specific floor plan feature of the plurality of floor plan features is selected to increase or maximize a consumption reduction.

Medium 700 comprises instructions 703 to replace the specific floor plan feature by an alternative floor plan feature in the digital data file, the alternative floor plan feature to consume a reduced amount of printing resources. Such replacement may in some example take place for specific floor plan features classified as walls. In some examples, a plurality of specific floor plan features are replaced by a plurality of respective alternative floor plan features.

The present disclosure is described with reference to flow charts. Although the flow charts described above show a specific order of execution, the order of execution may differ from that which is depicted. Blocks described in relation to one flow chart may be combined with those of another flow chart.

It shall be understood that some blocks in the flow charts can be realized using machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode. Further, some teachings herein may be implemented in the form of a computer software product, the computer software product being stored in a storage medium and comprising a plurality of instructions for making a computer device implement the methods recited in the examples of the present disclosure.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of operating a surface marking robot, comprising:
receiving a first digital representation of a floor plan, the first digital representation comprising a plurality of floor plan features;
identifying a specific floor plan feature of the plurality of floor plan features, the specific floor plan feature corresponding to a specific printing resources consumption; and
in response to identifying the specific floor plan feature, modifying the first digital representation to produce a second digital representation, whereby the specific floor plan feature is replaced in the second digital representation by an alternative floor plan feature, the alternative floor plan feature corresponding to an alternative printing resources consumption, whereby the alternative printing resources consumption is reduced compared to the specific printing resources consumption.

2. The method according to claim 1, whereby the printing resources are one of a printing time, a printing material amount and a surface marking robot energy.

3. The method according to claim 1, whereby the specific floor plan feature is one of a wall, a window, a door, a lighting point and a power plug.

4. The method according to claim 1, whereby the alternative floor plan feature comprises at least one of a text, a T shape and an arrow.

5. The method according to claim 1, the method further comprising applying printing material onto a floor using the surface marking robot and based on the second digital representation.

6. A surface marking robot comprising:
a body;
a print apparatus comprising a plurality of print nozzles mounted on the body;
a controller of the print apparatus;
a position detection apparatus to determine a position of the robot;
a motion control system, to cause the robot to travel along the surface with an intended path;
wherein the print apparatus is to deposit printing material onto the surface as the robot follows the intended path; and
wherein upon reception by the controller of the print apparatus of a first digital representation of a floor plan:
(i) the controller of the print apparatus is to identify a specific floor plan feature of the first digital representation corresponding to a specific printing resources consumption; and
(ii) the controller of the print apparatus is to replace the specific floor plan feature by an alternative floor plan feature, the alternative floor plan feature corresponding to an alternative printing resources consumption, whereby the alternative printing resources consumption is reduced compared to the specific printing resources consumption.

7. The surface marking robot according to claim 6, whereby the plurality of print nozzles define a swath height, wherein the specific floor plan feature has a width exceeding a printhead swath height, wherein the alternative floor plan feature has a width of less than or equal to the printhead swath height, and whereby the specific printing resources consumption and the alternative printing resources consumption each correspond to a printing time.

8. The surface marking robot according to claim 7, wherein the alternative floor plan feature is to be printed in a single swath.

9. The surface marking robot according to claim 8, wherein the specific floor plan feature represents a wall.

10. A non-transitory machine-readable storage medium encoded with instructions executable by a processor of a controller of a print apparatus of a surface marking robot, the machine-readable storage medium comprising:
instructions to process a digital data file corresponding to a floor plan, the digital data file comprising a plurality of floor plan features;
instructions to select a specific floor plan feature of the plurality of floor plan features; and
instruction to replace the specific floor plan feature by an alternative floor plan feature in the digital data file, the alternative floor plan feature to consume a reduced amount of printing resources.

11. The non-transitory machine-readable storage medium according to claim 10, wherein the plurality of floor plan features are classified according to floor plan feature classes.

12. The non-transitory machine-readable storage medium according to claim 11, whereby the floor plan feature classes comprise a wall class, the specific floor plan feature pertaining to the wall class, the specific floor plan feature comprising hosted wall elements, the alternative floor plan feature comprising information related to the hosted wall elements.

13. The non-transitory machine-readable storage medium according to claim 10, further comprising instructions to detect, in the digital data file, two parallel lines offset by a distance below a first predetermined threshold, the two parallel lines having a length above a second predetermined threshold, the two parallel lines corresponding to the selected specific floor plan feature.

14. The non-transitory machine-readable storage medium according to claim 13, the alternative floor plan feature comprising a single line and a wall thickness indication.

15. The non-transitory machine-readable storage medium according to claim 10, whereby the digital data file is a specific layer of a three dimensional representation of the floor plan.
